(19) United States
(12) Patent Application Publication
(10) Pub. No.: US 2015/0063224 A1
(43) Pub. Date: Mar. 5, 2015

(54) METHOD AND APPARATUS FOR AVOIDING OUT-OF-SYNCHRONIZATION WITH A NETWORK

(71) Applicant: QUALCOMM Incorporated, San Diego, CA (US)

(72) Inventors: Ansah Ahmed SHEIK, West Godavari District (IN); Liangchi HSU, San Diego, CA (US)

(73) Assignee: QUALCOMM Incorporated, San Diego, CA (US)

(21) Appl. No.: 14/196,860

(22) Filed: Mar. 4, 2014

Related U.S. Application Data
(60) Provisional application No. 61/872,117, filed on Aug. 30, 2013.

(51) Int. Cl. H04W 76/02; H04W 72/02

(52) U.S. Cl. CPC H04W 76/027; H04W 72/02
USPC 370/329

(57) ABSTRACT

Methods and apparatuses relating to wireless communication of a user equipment (UE) are provided including communicating with a network using a first channel configuration, receiving a second channel configuration from the network indicating a second channel for communicating with the network, and determining whether the second channel configuration is valid based at least in part on one or more parameters. Where the second channel configuration is valid, the second channel is configured for communicating with the network. Where the second channel configuration is not valid, the second channel configuration is rejected and use of the first channel configuration is continued.

### CLAIM OF PRIORITY UNDER 35 U.S.C. §119

The present application claims priority to Provisional Application No. 61/872,117, entitled “METHOD AND APPARATUS FOR AVOIDING OUT-OF-SYNCHRONIZATION WITH A NETWORK,” filed Aug. 30, 2013, the entirety of which is incorporated by reference herein.

### BACKGROUND

Aspects of the present disclosure relate generally to wireless communication systems, and more particularly, to an apparatus and method for avoiding out-of-synchronization with a network when a network sends an invalid network configuration.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Currently, during high-speed downlink packet access (HSDPA) or high-speed uplink packet access (HSUPA) radio access bearer (RAB) configuration, a discrepancy may exist that can result in a user equipment (UE) being without a transport channel. In particular, during RAB setup for HSDPA or HSUPA, transport channels for a legacy configuration (e.g., UMTS Release-99 (R99)) may be deleted, though the UE or network may not satisfy all conditions required to use the HSDPA or HSUPA bearers attempting setup, which can result in the UE and network being out-of-synchronization.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of wireless communication of a user equipment (UE) is provided. The method includes communicating with a network using a first channel configuration, receiving a second channel configuration from the network indicating a second channel for communicating with the network, determining whether the second channel configuration is valid based at least in part on one or more parameters, configuring the second channel for communicating with the network where the second channel configuration is valid, and rejecting the second channel configuration and continuing to use the first channel configuration where the second channel configuration is not valid.

In another aspect, an apparatus for wireless communication of a UE is provided. The apparatus includes means for communicating with a network using a first channel configuration, means for receiving a second channel configuration from the network indicating a second channel for communicating with the network, means for determining whether the second channel configuration is valid based at least in part on one or more parameters, means for configuring the second channel for communicating with the network where the second channel configuration is valid, and means for rejecting the second channel configuration and continuing to use the first channel configuration where the second channel configuration is not valid.

In a further aspect, an apparatus of wireless communication of a UE is provided including a call processing component configured for communicating with a network using a first channel configuration, a receiving component configured for receiving a second channel configuration from the network indicating a second channel for communicating with the network, a determining component configured for determining whether the second channel configuration is valid based at least in part on one or more parameters, a configuring component configured for configuring the second channel for communicating with the network where the second channel configuration is valid, and a rejecting component configured for rejecting the second channel configuration and continuing to use the first channel configuration where the second channel configuration is not valid.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram illustrating exemplary aspect of call processing in a wireless communication system;

FIG. 2 is a schematic diagram illustrating exemplary aspect of call channel configuration in a wireless communication system;

FIG. 3 is a flow diagram illustrating an exemplary method for call processing in a wireless communication system;

FIG. 4 is a flow diagram illustrating an exemplary method for processing invalid channel configurations in a wireless communication system;

FIG. 5 is a block diagram illustrating an example of a hardware implementation for an apparatus employing a processing system to perform the functions described herein;

FIG. 6 is a block diagram conceptually illustrating an example of a telecommunications system including a UE configured to perform the functions described herein;

FIG. 7 is a conceptual diagram illustrating an example of an access network for use with a UE configured to perform the functions described herein;

FIG. 8 is a conceptual diagram illustrating an example of a radio protocol architecture for the user and control planes for a base station and/or a UE configured to perform the functions described herein; and

FIG. 9 is a block diagram conceptually illustrating an example of a Node B in communication with a UE in a telecommunications system configured to perform the functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Described herein are various aspects related to avoiding out-of-synchronization when a network sends to a user equipment (UE) an invalid configuration for network resources. In particular, the UE can utilize a first channel configuration with the network to engage in a call. Where the UE then receives a reconfiguration message from the network having parameters relating to a second channel configuration, the UE can verify that the second channel configuration is valid before configuring the parameters, as the parameters may also specify to delete resources of the first channel configuration. If the second channel configuration is not valid, the UE can increment a counter to track a number of invalid configurations related to other channel configurations received from the network, and can continue using the first channel configuration. When the counter achieves a threshold, the UE can notify of the invalid channel configuration or of network unavailability, can enter an idle state, may initiate cell reselection or update, and/or perform other actions. In this regard, rather than immediately abandoning the first channel configuration in favor of the second channel configuration, the UE maintains the first channel configuration for a period of time until it verifies that the second channel configuration is valid. If the network insists on the second channel configuration, but the configuration is invalid, the UE can then take an alternative action.

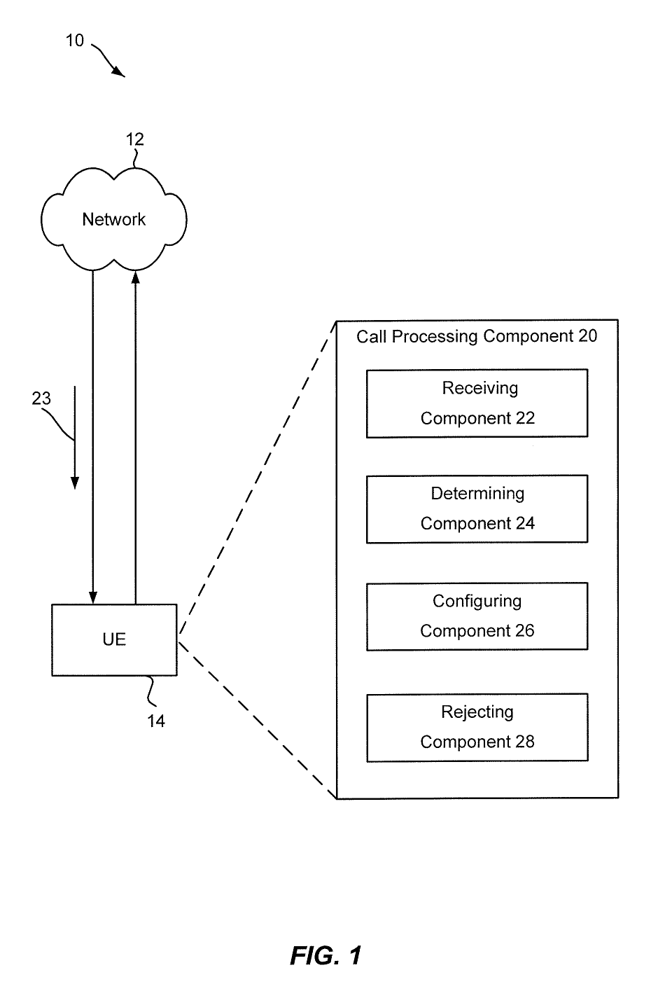

Referring to FIG. 1, in one aspect of the present apparatus and method, a wireless communication system 10 is configured to include wireless communications between network 12 and UE 14. The wireless communication system 10 may be configured to support communications between a number of users. FIG. 1 illustrates a manner in which network 12 communicates with UE 14. The wireless communication system 10 can be configured for downlink message transmission or uplink message transmission, as represented by the up/down arrows between network 12 and UE 14.

In an aspect, the UE 14 can include a call processing component 20. The call processing component 20 may be configured, among other things, to include a receiving component 22 configured for receiving a configuration message 23, which can relate to or include a channel configuration from the network 12. In a specific example, the configuration message 23 can include high-speed downlink packet access (HSDPA) configuration information or high-speed uplink packet access (HSUPA) configuration information. The call processing component 20 may also be configured to include determining component 24 configured for determining whether the configuration information related to the channel configuration message is valid, a configuring component 26 configured for configuring the UE based on the channel configuration information in the configuration message when the configuration is valid, and a rejecting component 28 configured for rejecting the configuration message 23 when the configuration is invalid.

In an example, call processing component 20 can initiate a call with network 12 over a first channel configuration, which can have been configured by the network 12 to include one or more channels over which the UE 14 can communicate with the network 12 to perform the call. During the call (e.g., the call itself, an initialization procedure for the call, etc.), call processing component 20 can receive configuration message 23 from the network 12 regarding a second channel configuration. For instance, the second channel configuration can provide improved performance over the first channel configuration. In an example, the second channel configuration can use a different radio access technology (RAT) or a different implementation of the RAT.

Determining component 24 can determine whether the second channel configuration received from the network 12 is valid before deleting or deactivating channels or other resources related to the first channel configuration. Where determining component 24 determines the second channel configuration is valid, configuring component 26 can configure the second channel based on parameters received in the second channel configuration from the network 12, and UE 14 can continue the call with the network 12 using the second channel configuration. In addition, in this regard, UE 14 can delete or deactivate channels or other resources related to the first channel configuration. Instructions for deleting or deactivating these channels or other resources can be provided in the second channel configuration received from the network 12.

Where determining component 24 determines the second channel configuration is invalid, however, rejecting component 28 can reject the second channel configuration, which can include not activating the second channel configuration and retaining channels/resources related to the first channel configuration for communicating with the network 12 (e.g., to continue the call). In addition, rejecting component 28 can increment a counter related to receiving invalid channel configurations from the network 12. When this counter exceeds a threshold, the UE 14 can take one or more invalid channel configuration actions, such as to notify of invalid network configuration or temporary unavailability. In another example, the UE 14 can enter an idle state and/or initiate cell reselection where the counter exceeds the threshold. It is to be appreciated that rejecting component 28 can initialize the counter upon initiating connection with network 12, when the counter exceeds the threshold and the UE 14 takes the alternative action to notify of the invalid configuration, enter idle mode, initiate cell reselection, etc., and/or the like.

In a specific example, the second channel configuration provide by configuration message 23 can relate to HSDPA or HSUPA, and the UE 14 can configure HSDPA based on certain criteria, according to radio resource control (RRC) Spec (3GPP RRC Spec TS25.331). For example, UE 14 can configure HSDPA if a HS_DSCH_RECEPTION variable, which indicates whether high-speed downlink shared channel (HS-DSCH) can be received, is set to TRUE. The HS_DSCH_RECEPTION can be set to TRUE when the following conditions are met (Section 8.5.25, 3GPP RRC Spec TS25.331): UE 14 is in cell dedicated channel (CELL_DCH) state; a valid HS-DSCH radio network terminal identifier (H_RNTI) is present; the UE 14 has valid “high-speed shared control channel (HS-SCCH) info” and “hybrid automatic repeat/request (HARQ) info;” at least one Radio link in the active set is configured as the serving HS-DSCH radio link; at least one resource block (RB) is mapped to HS-DSCH; and HSDPA medium access control (MAC-hs or MAC-ehs) queue is configured.

Thus, when receiving component 22 receives configuration message 23 with an HSDPA channel configuration during a call (e.g., where the call is initially setup using Release-99 (R99) dedicated channel (DCH)), determining component 24 can determine whether the HSDPA channel configuration is valid based on determining whether the above criteria are met and/or on whether HS_DSCH_RECEPTION is TRUE. If so, configuring component 26 configures the HSDPA channel and deletes the R99 channel. It is to be appreciated that the HSDPA channel configuration received from the network 12 may include instructions for deleting the R99 channel. If not, rejecting component 28 rejects the HSDPA channel configuration, increments a counter, and continues using the R99 DCH for the call, but if the counter reaches a threshold upon incrementing, call processing component 20 can notify of an invalid network configuration, can enter an idle state, can initiate cell reselection, or can perform other alternative actions, which may include deleting the R99 DCH or related resources.

Similarly, UE 14 can configure HSUPA if E_DCH_TRANSMISSION variable, which indicates whether the UE 14 is capable of communicating over an enhanced dedicated channel (E-DCH), is set to TRUE. The E_DCH_TRANSMISSION may be set to TRUE when the following conditions are met (Section 8.5.25, 3GPP RRC Spec TS25.331): UE 14 is in CELL_DCH state; primary E-DCH radio network terminal identifier (E-RNTI) or the Secondary E-RNTI or both are present; E-DCH time transmit interval (TTI), HARQ info, “E-DCH dedicated physical control channel (E-DPCCH) info” and “E-DCH dedicated physical data channel (E-DPDCH) info” are present; at least one Radio link in the active set is configured E-DCH which has access grant channel (AGCH) and HARQ indicator channel (HICH); at least one RB mapped to E-DCH and corresponding E-DCH MAC-d flow; and E-DCH MAC-d flow maximum number of retransmissions and the transmission grant type are configured.

Thus, when receiving component 22 receives configuration message 23 with an HSUPA channel configuration during a call (e.g., where the call is setup using Release-99 (R99) dedicated channel (DCH)), determining component 24 can determine whether the HSUPA channel configuration is valid based on determining whether the above criteria are met and/or on whether E_DCH_TRANSMISSION is TRUE. If so, configuring component 26 configures the HSUPA channel and deletes the R99 channel. It is to be appreciated that the HSUPA channel configuration received from the network 12 may include instructions for deleting the R99 channel. If not, rejecting component 28 rejects the HSUPA channel configuration, increments a counter, and continues using the R99 DCH for the call, but if the counter reaches a threshold upon incrementing, call processing component 20 can notify of an invalid network configuration, can enter an idle state, can initiate cell reselection, or can perform other alternative actions, which may include deleting the R99 DCH or related resources.

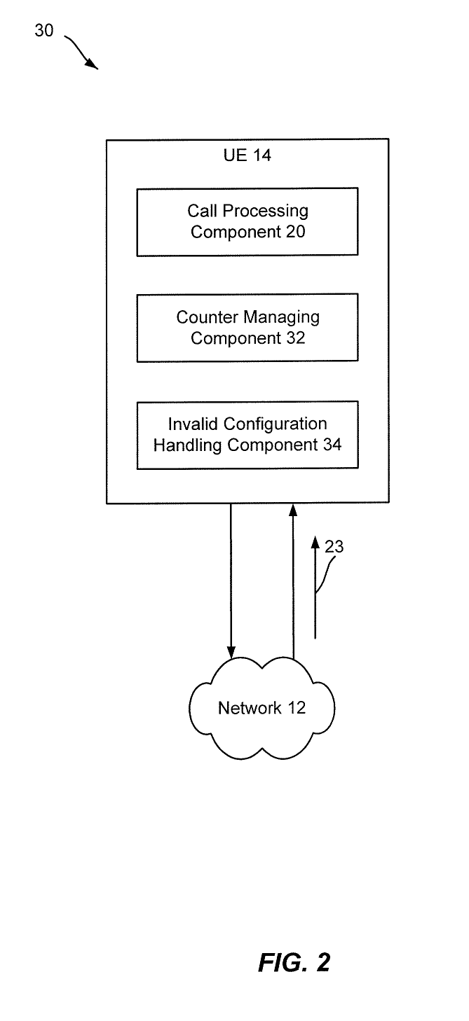

Referring to FIG. 2, in another aspect of the present apparatus and method, a wireless communication system 30 is configured to include wireless communications between network 12 and UE 14. The wireless communication system 30 may be configured to support communications between a number of users. FIG. 2 illustrates, in another aspect, a manner in which network 12 communicates with UE 14. The wireless communication system 10 can be configured for downlink message transmission or uplink message transmission, as represented by the up/down arrows between network 12 and UE 14.

In an aspect, the UE 14 can include the call processing component 20, as discussed in FIG. 1, and can also include a counter managing component 32 for initializing and managing a counter for receiving invalid channel configurations, and an invalid configuration handling component 34 for processing an invalid configuration when the counter reaches a threshold.

According to an example, call processing component 20 can communicate with network 12 over a first channel configuration, such as a R99 DCH configuration, in handling a call. Call processing component 20 can receive configuration message 23 with a second channel configuration during the call, such as a HSDPA and/or HSUPA configuration, and can determine whether the second channel configuration is valid, as described. Where call processing component 20 determines the second channel configuration is invalid and continues to use the first channel configuration in communicating with the network 12, counter managing component 32 can increment a counter for counting invalid channel configurations received from network 12. For example, counter managing component 32 can have initialized the counter upon initiating communications with the network 12 and/or once the counter reaches a threshold.

For example, counter managing component 32 can determine whether the incrementing the counter causes the counter to achieve a threshold. Where incrementing the counter does result in the counter achieving a threshold, invalid configuration handling component 34 can determine the second channel configuration is invalid, and can perform one or more related actions. For example, invalid configuration handling component 34 can notify of the invalid channel configuration, which can include displaying a notification on a display of the UE 14, indicating such in a communication such as an email or text message, etc. In another example, invalid configuration handling component 34 can switch the UE 14 to an idle mode based on the counter reaching the threshold. In yet another example, invalid configuration handling component 34 can start cell reselection or cell update procedures for the UE 14 based on the counter reaching the threshold. Moreover, in another example, invalid configuration handling component 34 can ensure that UE 14 does not attempt access to network 12 for a period of time.

In addition, for example, counter managing component 32 can reset the counter based on the counter achieving the threshold. The threshold for the counter can be configured for the UE 14 in hardcoding, based on a configuration file on the UE 14, a received configuration from the network 12 or other networks, and/or the like. Moreover, in an example, the threshold can be tuned based on various parameters so that the number of invalid channel configurations is large enough to accommodate for actual errors in configuration and/or to allow the UE 14 to verify HSDPA and/or HSUPA configuration, while being small enough to prevent the network 12 from wasting resources on continuing to send invalid channel configurations.

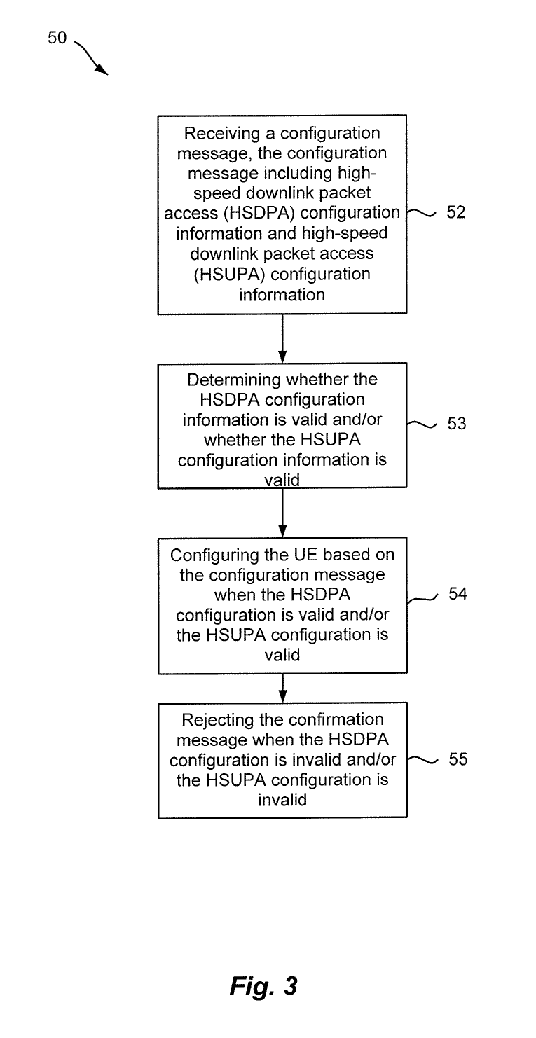

FIG. 3 is a flow diagram illustrating an exemplary method 50 for configuring a UE according to a received channel configuration or rejecting the channel configuration. At 52, a configuration message is received, the configuration message including HSDPA configuration information and HSUPA configuration information. For example, the configuration message 23 can be received during a call where the call is performed using a R99 DCH or other channel configuration. Thus, the received configuration message 23 can attempt to modify the channel configuration to provide improved resource configuration.

At 53, it can be determined whether the HSDPA configuration information is valid and/or whether the HSUPA configuration information is valid. For example, this can include verifying one or more parameters related to HSDPA or HSUPA configuration, verifying that a HS_DSCH_RECEPTION variable is TRUE, verifying a E_DCH_TRANSMISSION variable is TRUE, and/or the like, as described above.

At. 54, the UE can be configured based on the configuration message when the HSDPA configuration is valid and/or the HSUPA configuration is valid. For example, where it is determined that the configuration information is valid at 53, information in the configuration is used to setup an HSDPA or HSUPA channel at the UE, over which a call can be continued if in progress. In addition, the configuration information may include information for deleting resources of the first channel configuration (e.g., an R99 DCH configuration).

At 55, the confirmation message can be rejected when the HSDPA configuration is invalid and/or the HSUPA configuration is invalid. This can include retaining the first channel configuration (e.g., an R99 DCH configuration), and not configuring the HSDPA or HSUPA. In addition, when the confirmation is rejected, a counter for rejecting channel configuration messages can be incremented and verified to determine whether the incremented value exceeds a threshold. If the incremented value exceeds the threshold, alternate actions can be taken to process the invalid channel configuration, as described herein.

In an aspect, for example, the executing method 50 may be UE 14 or network 12 (FIG. 1) executing the call processing component 20 (FIG. 1), or respective components thereof.

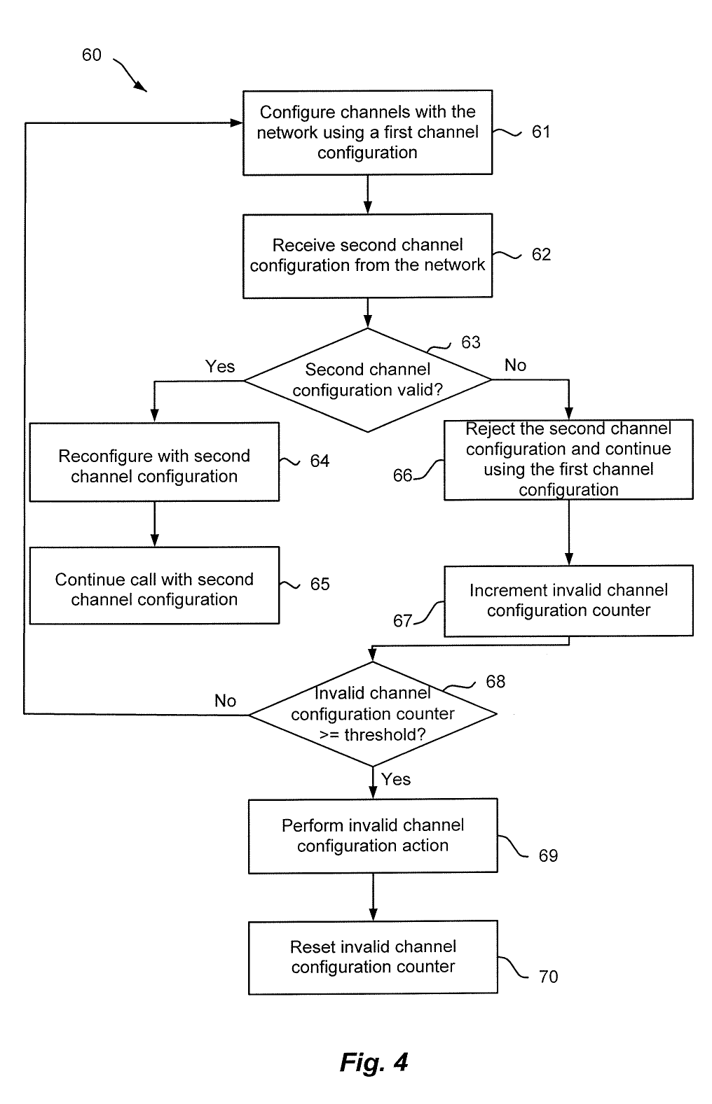

FIG. 4 is a flow diagram illustrating an exemplary method 60 for configuring a UE according to received channel configurations.

At 61, channels are configured with the network using a first channel configuration. As described, this can be a R99 DCH configuration and can allow for performing a call between a UE and a network.

At 62, a second channel configuration can be received from the network. As described, this can relate to receiving configuration message 23 including an improved channel configuration such as HSDPA, HSUPA, etc. In addition, the second channel configuration can include parameters for deleting the first channel configuration.

At 63, it can be determined whether the second channel configuration is valid. This can include determining whether the UE can support the channel configuration based on verifying one or more criteria or variables, as described above.

If the second channel configuration is valid, then at 64, reconfiguration occurs with the second channel configuration. This can include establishing HSDPA and/or HSUPA channels based on the second channel configuration and/or deleting R99 DCH channels or related resources. Moreover, at 65, a call can be continued using the second channel configuration.

If the second channel configuration is not valid, then at 66, the second channel configuration is rejected and use of the first channel configuration is continued. It is to be appreciated that rejecting the channel configuration can include notifying the network of rejection and/or not using the channel configuration. This can also include not following instructions in the second channel configuration to delete the first channel configuration.

In addition, at 67, an invalid channel configuration counter is incremented. As described, this counter can be initialized when initiating communication in the network. After the counter is incremented, it can be determined whether the invalid channel configuration counter is greater than or equal to a threshold at 68. If so, an invalid channel configuration action can be performed at 69. The invalid channel configuration action can relate to notifying of an invalid channel configuration or network outage, transitioning to an idle mode, performing cell reselection, etc., as described. Then, at 70, the invalid channel configuration counter may be reset. If the invalid channel configuration counter is less than the threshold at 68, the method can continue to step 61 where the first channel configuration is used.

In an aspect, for example, the executing method 60 may be UE 14 or network 12 (FIG. 1) executing the call processing component 20 (FIG. 1) or other components in FIG. 2, or respective components thereof.

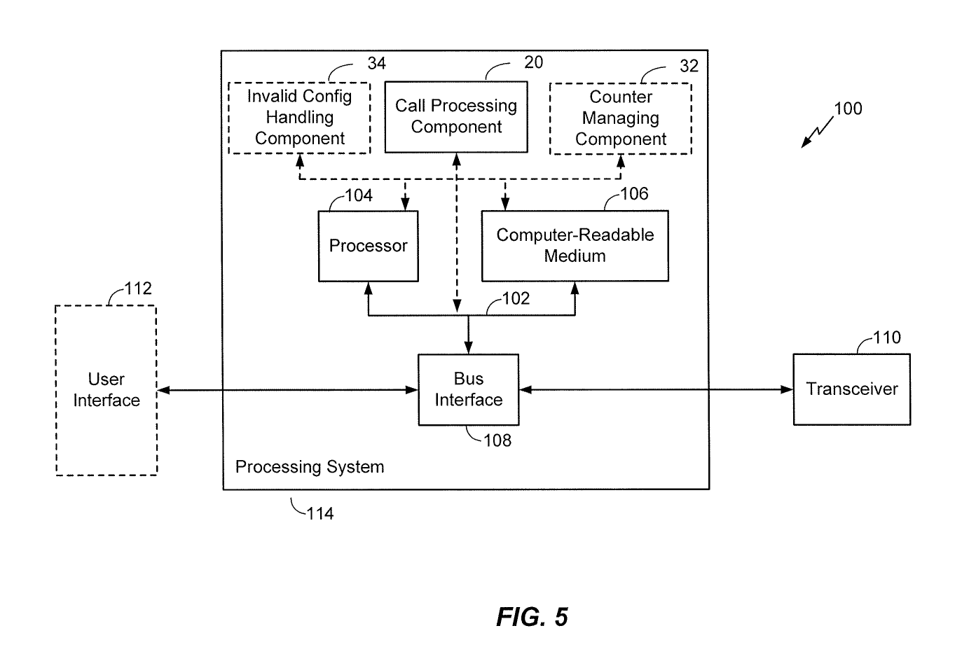

FIG. 5 is a block diagram illustrating an example of a hardware implementation for an apparatus 100 employing a processing system 114. Apparatus 100 may be configured to include, for example, UE 14 (FIGS. 1 and 2), and one or more of call processing component 20 (FIG. 1), counter managing component 32 (FIG. 2), invalid configuration handling component 34 (FIG. 2), or other components of the UE 14, etc., as described above. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

In an aspect, processor 104, computer-readable medium 106, or a combination of both may be configured or otherwise specially programmed to perform the functionality of the call processing component 20 (FIG. 1), counter managing component 32 (FIG. 2), invalid configuration handling component 34 (FIG. 2), etc, as described herein.

The various concepts presented throughout this disclosure may be implemented across a broad variety of telecommunication systems, network architectures, and communication standards.

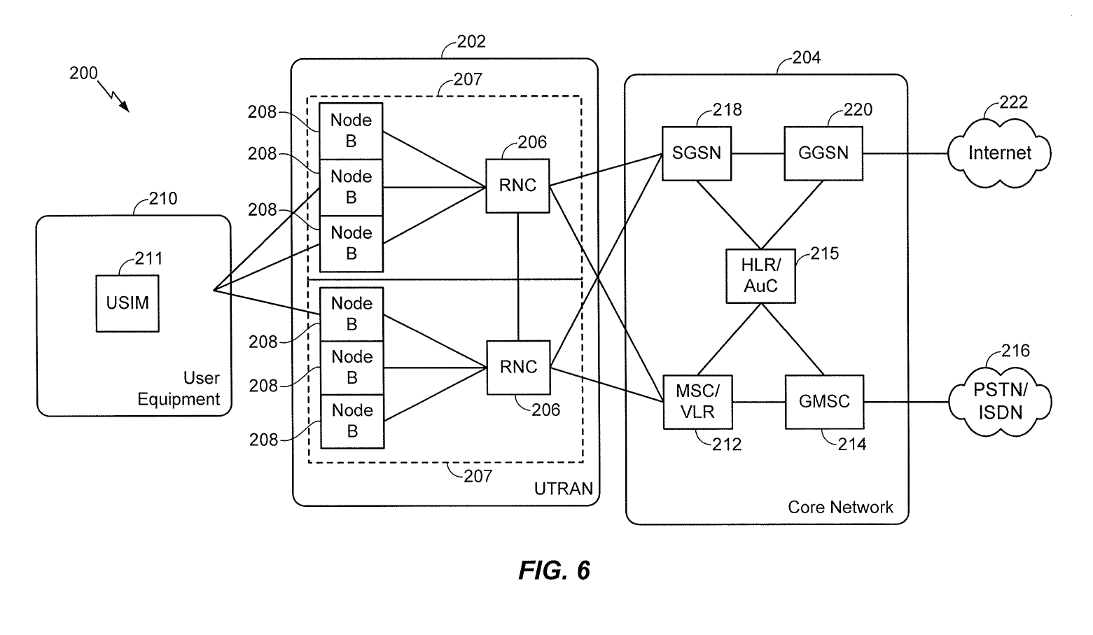

Referring to FIG. 6, by way of example and without limitation, the aspects of the present disclosure are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. UE 210 may be configured to include, for example, one or more of the call processing component 20 (FIG. 1), counter managing component 32 (FIG. 2), invalid configuration handling component 34 (FIG. 2), etc., as described above. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The UE 210 is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate, or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

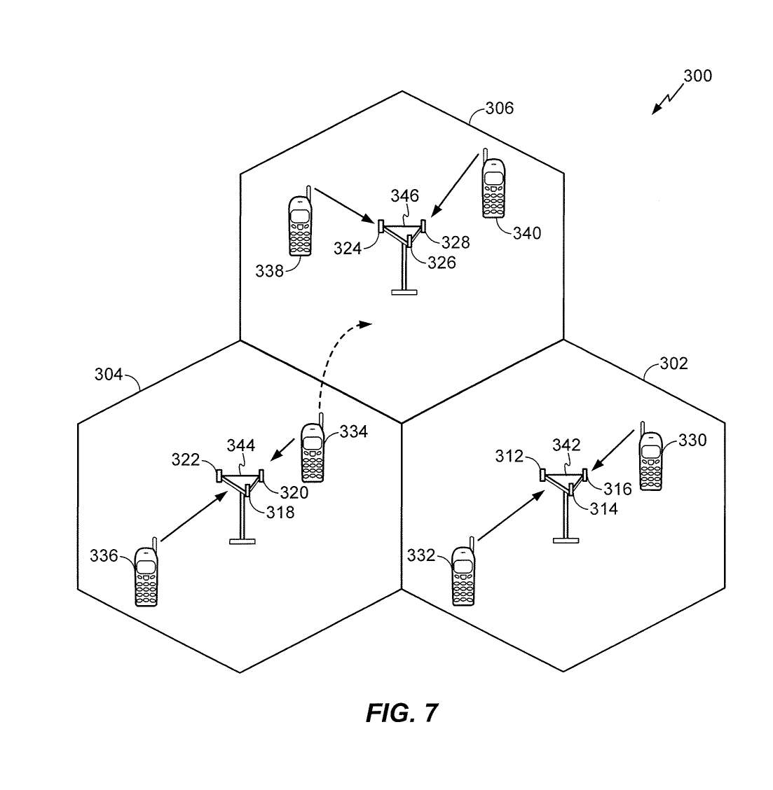

Referring to FIG. 7, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 6) for all the UEs 330, 332, 334, 336, 338, 340 in the respective cells 302, 304, and 306. Node Bs 342, 344, 346 and UEs 330, 332, 334, 336, 338, 340 respectively may be configured to include, for example, one or more of the call processing component 20 (FIG. 1), counter managing component 32 (FIG. 2), invalid configuration handling component 34 (FIG. 2), etc, as described above.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 6), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

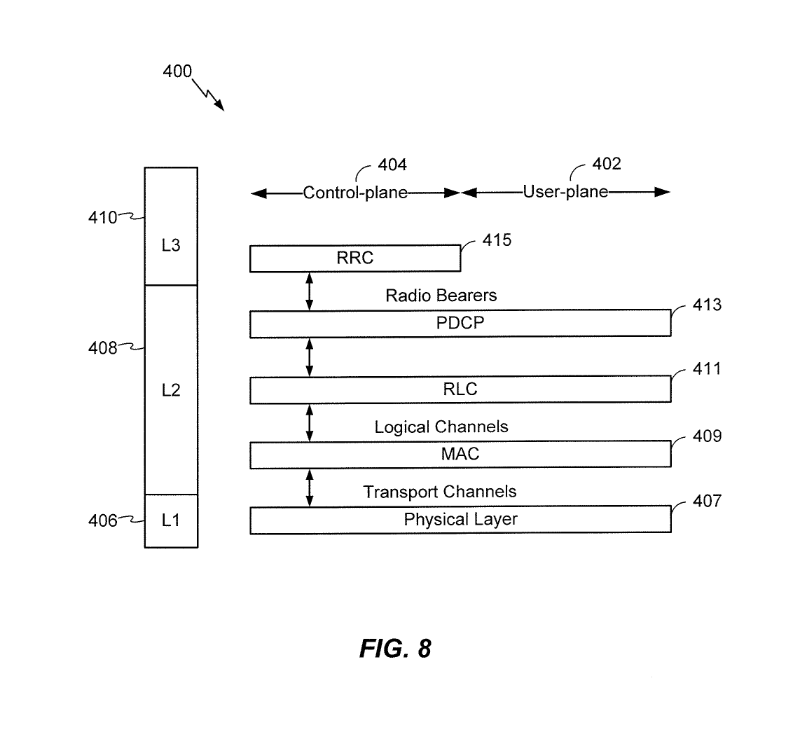

The radio protocol architecture may take on various forms depending on the particular application. An example for an HSPA system will now be presented with reference to FIG. 8.

FIG. 8 is a conceptual diagram illustrating an example of the radio protocol architecture 400 for the user plane 402 and the control plane 404 of a user equipment (UE) or node B/base station. For example, architecture 400 may be included in a network entity and/or UE such as an entity within wireless network 12 and/or UE14 (FIGS. 1 and 2). The radio protocol architecture 400 for the UE and node B is shown with three layers: Layer 1 406, Layer 2 408, and Layer 3 410. Layer 1 406 is the lowest lower and implements various physical layer signal processing functions. As such, Layer 1 406 includes the physical layer 407. Layer 2 (L2 layer) 408 is above the physical layer 407 and is responsible for the link between the UE and node B over the physical layer 407. Layer 3 (L3 layer) 410 includes a radio resource control (RRC) sublayer 415. The RRC sublayer 415 handles the control plane signaling of Layer 3 between the UE and the UTRAN.

In the user plane, the L2 layer 408 includes a media access control (MAC) sublayer 409, a radio link control (RLC) sublayer 411, and a packet data convergence protocol (PDCP) 413 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 413 provides multiplexing between different radio bearers and logical channels. The PDCP sublayer 413 also provides header compression for upper layer data packets to reduce radio transmission overhead, security by ciphering the data packets, and handover support for UEs between node Bs. The RLC sublayer 411 provides segmentation and reassembly of upper layer data packets, retransmission of lost data packets, and reordering of data packets to compensate for out-of-order reception due to hybrid automatic repeat request (HARQ). The MAC sublayer 409 provides multiplexing between logical and transport channels. The MAC sublayer 409 is also responsible for allocating the various radio resources (e.g., resource blocks) in one cell among the UEs. The MAC sublayer 409 is also responsible for HARQ operations.

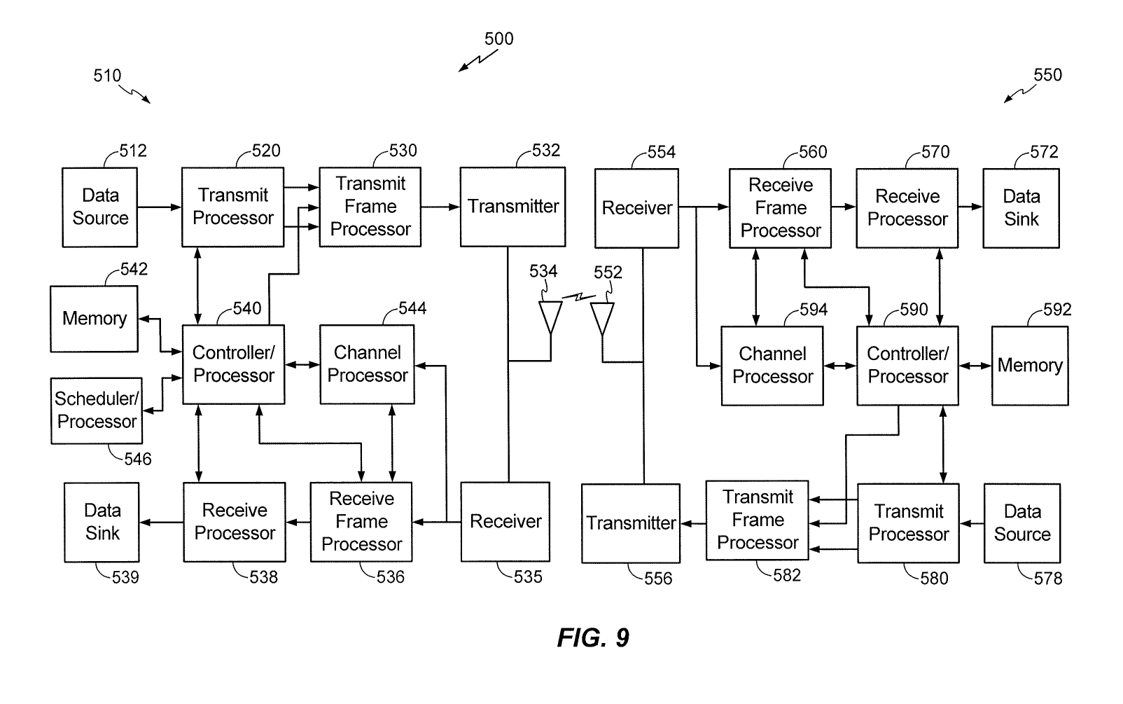

FIG. 9 is a block diagram of a communication system 500 including a Node B 510 in communication with a UE 550, where Node B 510 may be an entity within wireless network 12 and the UE 550 may be UE 14, including one or more of the call processing component 20 (FIG. 1), counter managing component 32 (FIG. 2), invalid configuration handling component 34 (FIG. 2), etc., according to the aspects described in FIGS. 1-4. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” or processor (FIG. 5) that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106 (FIG. 5). The computer-readable medium 106 (FIG. 5) may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication of a user equipment (UE), comprising:
communicating with a network using a first channel configuration;
receiving a second channel configuration from the network indicating a second channel for communicating with the network;
determining whether the second channel configuration is valid based at least in part on one or more parameters;
configuring the second channel for communicating with the network where the second channel configuration is valid; and
rejecting the second channel configuration and continuing to use the first channel configuration where the second channel configuration is not valid.

2. The method of claim 1, further comprising incrementing an invalid channel configuration counter where the second channel configuration is not valid.

3. The method of claim 2, further comprising:
determining that the invalid channel configuration counter achieves a threshold; and
performing an invalid channel configuration action based on determining that the invalid channel configuration counter achieves the threshold.

4. The method of claim 3, wherein the invalid channel configuration action includes at least one of notifying of an invalid channel configuration, transitioning to an idle state, or initiating cell reselection.

5. The method of claim 3, further comprising resetting the invalid channel configuration counter based on determining that the invalid channel configuration counter achieves the threshold.

6. The method of claim 1, wherein the configuring the second channel includes deleting resources related to the first channel configuration based on information included in the second channel configuration.

7. The method of claim 1, wherein the second channel configuration corresponds to a high-speed downlink packet access (HSDPA) configuration, and wherein determining whether the second channel configuration is valid comprises determining whether a variable that indicates whether high speed downlink shared channel (HS-DSCH) reception is enabled is TRUE.

8. The method of claim 1, wherein the second channel configuration corresponds to a high-speed downlink packet access (HSDPA) configuration, and wherein determining whether the second channel configuration is valid comprises verifying that:
a user equipment (UE) is in cell dedicated channel (CELL_DCH) state;
a valid high-speed downlink shared channel (HS-DSCH) radio network terminal identifier (H_RNTI) is present;
the UE has valid high-speed shared control channel (HS-SCCH) information and hybrid automatic repeat/request (HARQ) information;
at least one radio link in an active set is configured as a serving HS-DSCH radio link;
at least one resource block (RB) is mapped to a HS-DSCH; and
a HSDPA medium access control (MAC-hs or MAC-ehs) queue is configured.

9. The method of claim 1, wherein the second channel configuration corresponds to a high-speed uplink packet access (HSUPA) configuration, and wherein determining whether the second channel configuration is valid comprises determining whether a variable that indicates whether enhanced dedicated channel (E-DCH) transmission is enabled is TRUE.

10. The method of claim 1, wherein the second channel configuration corresponds to a high-speed uplink packet access (HSUPA) configuration, and wherein determining whether the second channel configuration is valid comprises verifying that:
a user equipment (UE) is in cell dedicated channel (CELL_DCH) state;
a primary E-DCH radio network terminal identifier (E-RNTI) or a secondary E-RNTI or both are present;
an enhanced dedicated channel (E-DCH) time transmit interval (TTI), hybrid automatic repeat/request (HARQ) information, E-DCH dedicated physical control channel (E-DPCCH) information, and E-DCH dedicated physical data channel (E-DPDCH) information are present;
at least one radio link in an active set is configured E-DCH which has access grant channel (AGCH) and HARQ indicator channel (HICH);
at least one RB mapped to E-DCH and corresponding E-DCH medium access control (MAC)-d flow; and
E-DCH MAC-d flow maximum number of retransmissions and a transmission grant type are configured.

11. The method of claim 1, wherein the first channel configuration corresponds to a Universal Mobile Telecommunications System (UMTS) Release 99 (R99) configuration for performing a call, and the second channel configuration corresponds to a high-speed downlink packet access (HSDPA) configuration or a high-speed uplink packet access (HSUPA) configuration for continuing the call.

12. An apparatus for wireless communication of a user equipment (UE), comprising:
means for communicating with a network using a first channel configuration;
means for receiving a second channel configuration from the network indicating a second channel for communicating with the network;
means for determining whether the second channel configuration is valid based at least in part on one or more parameters;
means for configuring the second channel for communicating with the network where the second channel configuration is valid; and
means for rejecting the second channel configuration and continuing to use the first channel configuration where the second channel configuration is not valid.

13. The apparatus of claim 12, further comprising means for incrementing an invalid channel configuration counter where the second channel configuration is not valid.

14. An apparatus of wireless communication of a user equipment (UE), comprising:
a call processing component configured for communicating with a network using a first channel configuration;
a receiving component configured for receiving a second channel configuration from the network indicating a second channel for communicating with the network;
a determining component configured for determining whether the second channel configuration is valid based at least in part on one or more parameters;
a configuring component configured for configuring the second channel for communicating with the network where the second channel configuration is valid; and
a rejecting component configured for rejecting the second channel configuration and continuing to use the first channel configuration where the second channel configuration is not valid.

15. The apparatus of claim 14, further comprising a counter managing component configured for incrementing an invalid channel configuration counter where the second channel configuration is not valid.

16. The apparatus of claim 15, further comprising an invalid configuration handling component configured for performing at least one of notifying of an invalid channel configuration, transitioning communications to an idle state, or initiating cell reselection based on the counter managing component determining that the invalid channel configuration counter achieves a threshold.

17. The apparatus of claim 14, wherein the configuring component is configured for configuring the second channel at least in part by deleting resources related to the first channel configuration based on information included in the second channel configuration.

18. The apparatus of claim 14, wherein the second channel configuration corresponds to a high-speed downlink packet access (HSDPA) configuration, and wherein the determining component is configured for determining whether the second channel configuration is valid at least in part by determining whether a variable that indicates whether high speed downlink shared channel (HS-DSCH) reception is enabled is TRUE.

19. The apparatus of claim 14, wherein the second channel configuration corresponds to a high-speed uplink packet access (HSUPA) configuration, and wherein the determining component is configured for determining whether the second channel configuration is valid at least in part by determining whether a variable that indicates whether enhanced dedicated channel (E-DCH) transmission is enabled is TRUE.

20. The apparatus of claim 14, wherein the first channel configuration corresponds to a Universal Mobile Telecommunications System (UMTS) Release 99 (R99) configuration for performing a call, and the second channel configuration corresponds to a high-speed downlink packet access (HSDPA) configuration or a high-speed uplink packet access (HSUPA) configuration for continuing the call.
